(19) United States
(12) Patent Application Publication
(10) Pub. No.: US 2014/0017556 A1
(43) Pub. Date: Jan. 16, 2014

(54) SOFT-PACKAGE LITHIUM BATTERY EDGEFOLD STRUCTURE

(71) Applicants: DONGGUAN AMPEREX TECHNOLOGY LIMITED, Dongguan (CN); NINGDE AMPEREX TECHNOLOGY LIMITED, Ningde City (CN)

(72) Inventors: Lianghai Liu, Dongguan (CN); Hongxing Fang, Dongguan (CN); Yaohui Wang, Dongguan (CN); Baiqing Zhang, Dongguan (CN); Xiaohua Zhang, Dongguan (CN)

(73) Assignees: NINGDE AMPEREX TECHNOLOGY LIMITED, Ningde City (CN); DONGGUAN AMPEREX TECHNOLOGY LIMITED, Dongguan (CN)

(21) Appl. No.: 13/747,931

(22) Filed: Jan. 23, 2013

(30) Foreign Application Priority Data
Jul. 10, 2012 (CN) 201210237239.1

(51) Int. Cl. H01M 2/08

(52) U.S. Cl. CPC H01M 2/08
USPC 429/185

(57) ABSTRACT

The invention discloses a soft-package lithium battery edgefold structure, comprising a side edge of a soft-package lithium battery and a double edgefold folded by using a packing aluminium foil of the cell of the soft-package lithium battery, wherein a glue layer is arranged between the double edgefold and the side edge, one side of the glue layer is glued with the side edge, while the other side of the glue layer is glued with the double edgefold. The invention has the advantages in that edge glue is needless, capable of preventing metal in the position of scrap edge from outleakage, preventing width of the battery cell at a fixed side edge from increasing, and being easier for realization of automatic production than usually applying edge glue.

### FIELD OF THE INVENTION

The invention relates to the technology field of a soft-package lithium battery, in particular to a soft-package lithium battery edgefold structure.

### BACKGROUND OF THE INVENTION

In the conventional soft-package structure, in order to prevent a battery cell from corrosion or short circuit, a plurality of methods are adopted to envelop the exposed aluminum layer of a battery edge sealing resulted from scrap edge. FIG. 1 shows the structure of a conventional single edgefold fixed by applying edge glue, a battery cell body 1 forms a battery cell side wall 2 after being encapsulated by a packaging aluminium foil, a single edgefold 3 is formed by folding an encapsulation stamp, at last, the single edgefold 3 is fixed on the side wall 2 by using a layer of adhesive tape 4 with single-sided glue so as to guarantee good insulation of the scrap edge and prevent the single edgefold 3 from stretching. FIG. 2 shows the structure of a double edgefold 5 folded by the single edgefold, which can guarantee a smaller edgefold height can be formed under the condition of sufficient width of the encapsulation stamp.

Both structures shown in FIG. 1 and FIG. 2 have a disadvantage in that the edge glue needs applying to the battery cell body 1, thereby increasing the thickness thereof. The market has a higher and higher requirement for battery volume energy density. Just shown as FIG. 3, a patent for invention (Chinese patent number: 201120192837.2) discloses a soft-package lithium battery edge sealing fixed structure, in which, exposed metal at the encapsulation stamp is subject to insulated isolation by using an edge glue 6, the edge glue 6 is cohered on the battery cell side wall by using a glue. However, the structure has a high requirement for automation of equipment, with a high cost for manufacturing the edge glue but a low yield and productivity.

### SUMMARY OF THE INVENTION

The invention aims at, in allusion to disadvantages of the prior art, providing a soft-package lithium battery edgefold structure and a making method thereof, capable of improving the volume energy density of the battery cell, reducing production cost by cancelling the edge glue, and raising efficiency of automatic production and yield of products.

For achieving the objective, the invention provides a soft-package lithium battery edgefold structure with such a technical scheme as below:

A soft-package lithium battery edgefold structure, comprising a side edge of a soft-package lithium battery and a double edgefold folded by using a packing aluminium foil of the cell of the soft-package lithium battery, wherein a glue layer is arranged between the double edgefold and the side edge, one side of the glue layer is glued with the side edge, while the other side of the glue layer is glued with the double edgefold.

The double edgefold comprises a first edgefold and a second edgefold, in which, the first edgefold is close to the side edge.

The first edgefold has a minimum length more than 0.5 mm, and the length of the first edgefold is less than that of the second edgefold.

The external side of the first edgefold is 0.2-1 0 mm far away from that of the second edgefold.

One side of the glue layer is glued with the side edge, while the other side of the glue layer is glued with the internal side of the first edgefold.

One side of the glue layer is glued with the side edge, and the first edgefold is embedded into the glue layer.

One side of the glue layer is glued with the side edge, while the other side of the glue layer is glued with the internal side of the second edgefold.

The height of the double edgefold is less than or equal to that of the soft-package lithium battery.

The height of the double edgefold is larger than that of the soft-package lithium battery.

The invention has a beneficial effect in that: a double edgefold structure is adopted for a side of the soft-package lithium battery, the double edgefold is fixed by the glue layer on the lateral of the soft-package lithium battery, the edge glue is cancelled for reducing production cost, meanwhile the volume energy density of the battery cell is improved, and the efficiency of automatic production and yield of products are raised.

### BRIEF DESCRIPTION OF THE DRAWINGS

FIG. 1 is a structure diagram of structure of a single edgefold of an existing soft-package lithium battery lateral;

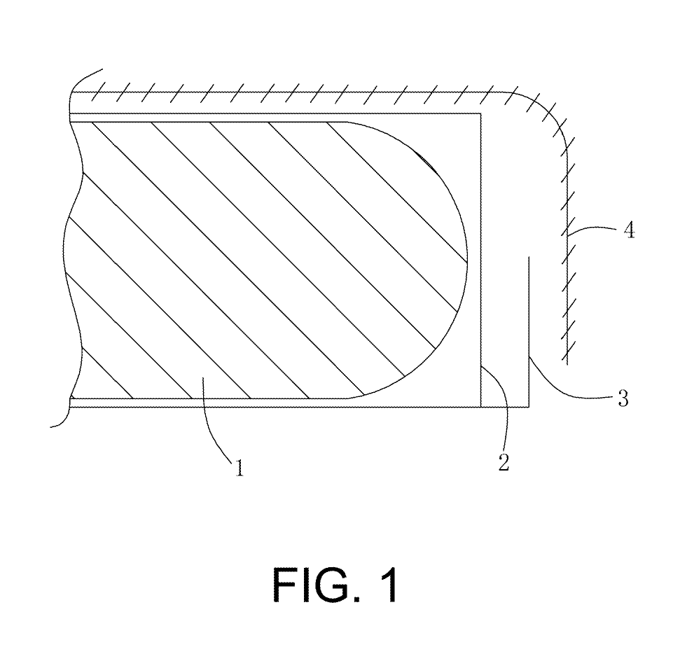

FIG. 2 is a structure diagram of structure of a double edgefold of an existing soft-package lithium battery lateral;

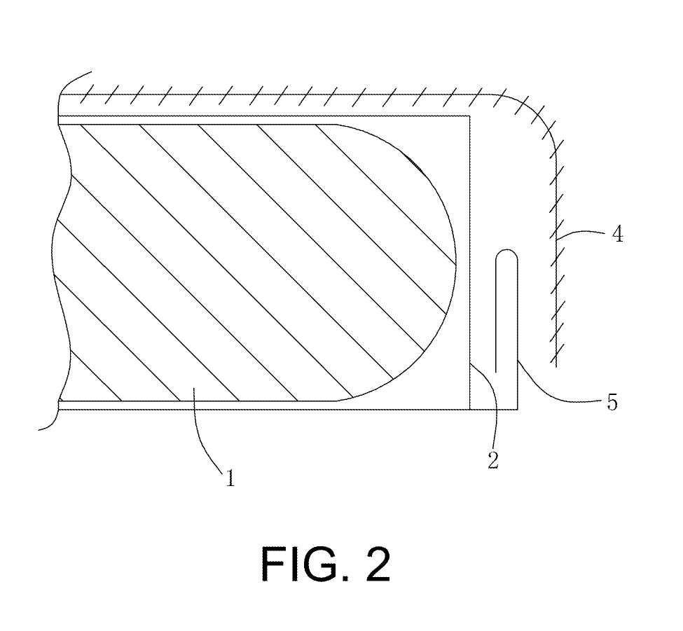

FIG. 3 is a structure diagram of the fixed structure of an existing soft-package lithium battery edge sealing;

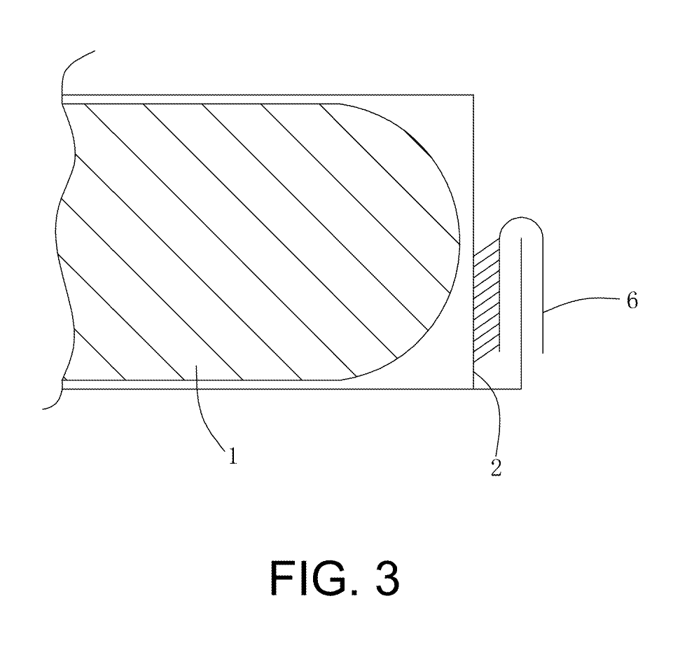

FIG. 4 is a structure diagram of the embodiment 1 of a soft-package lithium battery edgefold structure in the invention;

FIG. 5 is a structure diagram of the embodiment 2 of a soft-package lithium battery edgefold structure in the invention; and

FIG. 6 is a structure diagram of the embodiment 3 of a soft-package lithium battery edgefold structure in the invention.

### DETAILED DESCRIPTION OF THE EMBODIMENTS

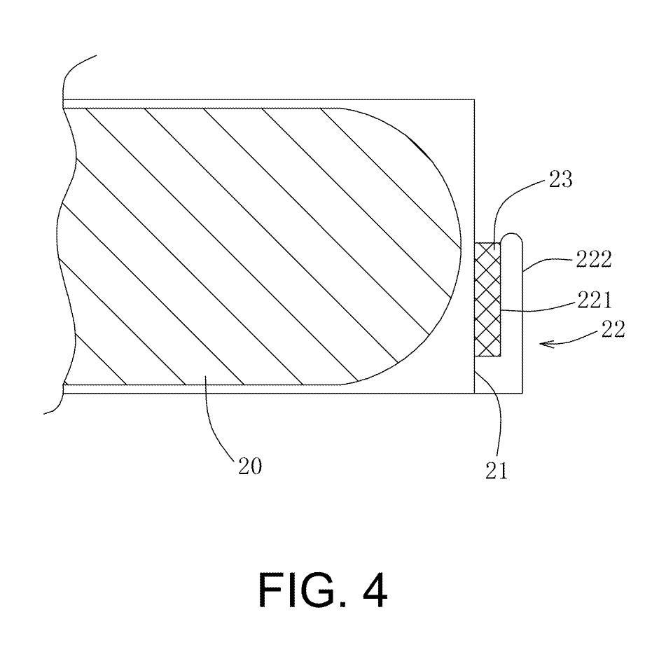

FIG. 4 shows the embodiment 1 of a soft-package lithium battery edgefold structure in the invention, comprising a side edge 21 of the soft-package lithium battery 20 and a double edgefold 22 folded by using a packing aluminium foil of the cell of the soft-package lithium battery 20, wherein a glue layer 23 is arranged between the double edgefold 22 and the side edge 21, one side of the glue layer 23 is glued with the side edge 21, while the other side of the glue layer 23 is glued with the double edgefold 33.

The double edgefold 22 comprises a first edgefold 221 and a second edgefold 222, in which, the first edgefold 221 is close to the side edge 21.

Preferably, the first edgefold 221 has a minimum length more than 0.5 mm, and the length of the first edgefold 221 is less than that of the second edgefold 222.

Preferably, the external side of the first edgefold 221 is 0.2-1.0 mm far away from that of the second edgefold 222.

In the embodiment, one side of the glue layer 23 is glued with the side edge 21, while the other side of the glue layer 23 is glued with the internal side of the first edgefold 221.

Preferably, the height of the double edgefold 22 is less than or equal to that of the soft-package lithium battery 20; of course, under the condition of specific requirement, the height of the double edgefold 22 can be more than that of the soft-package lithium battery 20.

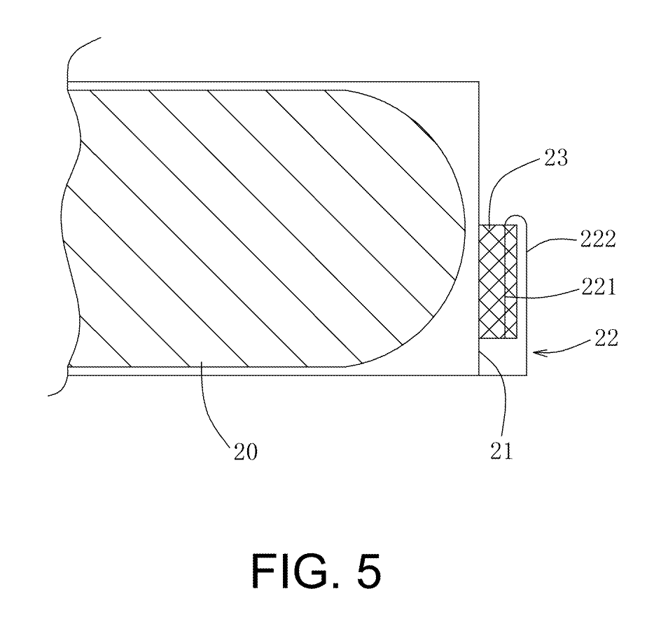

FIG. 5 shows the embodiment 2 of the invention. Different from the embodiment 1, in the embodiment 2, one side of the glue layer 23 is glued with the side edge 21, and the first edgefold 221 is embedded into the glue layer 23, other structures of the embodiment 2 are the same as those of the embodiment 1, not repeated any more.

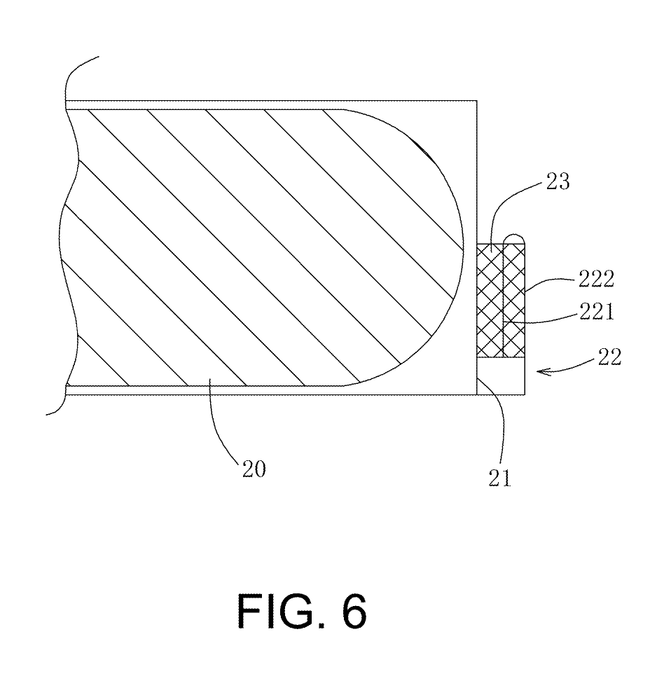

FIG. 6 shows the embodiment 3 of the invention. Different from the embodiment 1, in the embodiment 3, one side of the glue layer 23 is glued with the side edge 21, while the other side of the glue layer 23 is glued with the internal side of the second edgefold 222, other structures of the embodiment 3 are the same as those of the embodiment 1, not repeated any more.

From above description, those skilled in the art can change or modify the above-mentioned embodiments. Therefore, the invention is not limited to the above-mentioned embodiments. Some modification and alteration of the invention made by those skilled in the art are within the scope of protection of the claims in the invention. In addition, some specific terms are used in the specification for the convenience of description, but not to limit the invention.

What is claimed is:

1. A soft-package lithium battery edgefold structure, comprising a side edge of a soft-package lithium battery and a double edgefold folded by using a packing aluminium foil of the cell of the soft-package lithium battery, wherein a glue layer is arranged between the double edgefold and the side edge, one side of the glue layer is glued with the side edge, while the other side of the glue layer is glued with the double edgefold.

2. The soft-package lithium battery edgefold structure of claim 1, wherein the double edgefold comprises a first edgefold and a second edgefold, in which, the first edgefold is close to the side edge.

3. The soft-package lithium battery edgefold structure of claim 2, wherein the first edgefold has a minimum length more than 0.5 mm, and the length of the first edgefold is less than that of the second edgefold.

4. The soft-package lithium battery edgefold structure of claim 1, wherein the external side of the first edgefold is 0.2-1.0 mm far away from that of the second edgefold.

5. The soft-package lithium battery edgefold structure of claim 1, wherein one side of the glue layer is glued with the side edge, while the other side of the glue layer is glued with the internal side of the first edgefold.

6. The soft-package lithium battery edgefold structure of claim 1, wherein one side of the glue layer is glued with the side edge, and the first edgefold is embedded into the glue layer.

7. The soft-package lithium battery edgefold structure of claim 1, wherein one side of the glue layer is glued with the side edge, while the other side of the glue layer is glued with the internal side of the second edgefold.

8. The soft-package lithium battery edgefold structure of claim 1, wherein the height of the double edgefold is less than or equal to that of the soft-package lithium battery.

9. The soft-package lithium battery edgefold structure of claim 1, wherein the height of the double edgefold is larger than that of the soft-package lithium battery.
